(19) United States
(12) Patent Application Publication
(10) Pub. No.: US 2012/0195268 A1
(43) Pub. Date: Aug. 2, 2012

(54) NETWORK ACCESS METHOD AND WIRELESS COMMUNICATION DEVICE AND BASE STATION USING THE SAME

(75) Inventors: Wei-Chieh Huang, New Taipei City (TW); Ping-Heng Kuo, Pingtung County (TW); Chia-Lung Tsai, Keelung City (TW); Pang-An Ting, Taichung City (TW)

(73) Assignee: INDUSTRIAL TECHNOLOGY RESEARCH INSTITUTE, Hsinchu (TW)

(21) Appl. No.: 13/293,128

(22) Filed: Nov. 10, 2011

Related U.S. Application Data
(60) Provisional application No. 61/438,126, filed on Jan. 31, 2011.

(51) Int. Cl. H04W 72/04

(52) U.S. Cl. 370/329

(57) ABSTRACT

Network access methods and base stations and wireless communication devices using the same methods are proposed. The proposed method relies on random access parameters assignment through pre-configured information and non-uniform distribution of access timings corresponding to pre-assigned priority group.

### CROSS-REFERENCE TO RELATED APPLICATION

This application claims the priority benefit of U.S. provisional application Ser. No. 61/438,126, filed on Jan. 31, 2011. The entirety of the above-mentioned patent applications is hereby incorporated by reference herein and made a part of this specification.

### BACKGROUND OF THE INVENTION

1. Field of the Invention

The disclosure generally relates to a network access method, a wireless communication device and a base station using the same method.

2. Description of Related Art

Machine to Machine (M2M) communications (also called machine-type-communication, abbreviated as MTC) is a very distinct capability that enables the implementation of the “Internet of things”. It is defined as information exchange between a subscriber station (or a wireless communication device) and a server in the core network (through a base station) or just between subscriber stations, which may be carried out without any human interaction. Several industry reports have scoped out huge potential for this market. Given the huge potential, some novel broadband wireless access systems, such as 3GPP LTE and IEEE 802.16m, have started to develop enhancements for enabling M2M communications.

In some use case models of M2M communications, such as healthcare, secured access & surveillance, public safety, and remote maintenance & control, high priority access is necessary in order to communicate alarms, emergency situations or any other device states that require immediate attention. Besides, for battery-limited M2M devices, consuming extremely low operational power over long periods of time is required. Such M2M devices may be in idle mode at most time for power saving. Hence, prioritized ranging (or random access) is an essential function for idle M2M devices while they want to transmit delay-sensitive messages to the M2M server(s). On the other hand, in such urgent cases, the backbone wireless communication system should have ability to provide enough ranging capacity for those delay-sensitive applications even if it may be a rare case of mass ranging attempts for emergency occurring simultaneously.

According to current wireless communication standards, an idle mode of a wireless communication device may be only terminated through: the wireless communication device performing a network re-entry to the network; a paging controller in the wireless communication system detecting of the wireless communication device being unavailability through repeated, unanswered paging messages; expiration of the idle mode timer at the wireless communication device; entering another mode such as a deregistration with content retention (DCR) mode from the idle mode, and so forth. Further, the wireless communication device may terminate its idle mode at any time, and perform its network re-entry procedure with its preferred access base station.

In some cases when the wireless communication system or an M2M application server requires communication with the idle mode M2M device(s), paging mechanism may be triggered by the wireless communication system for the idle mode M2M device(s) performing the network re-entry procedure. Multiple groups of M2M devices may be grouped simultaneously, and thus while the M2M devices are performing network re-entry procedures, other wireless communication devices may also initiate random access (or ranging) for their respective voluntary transmission at the same time. This scenario may cause interruptions for the network re-entry of the M2M devices, which may be requested to provide emergency information. Therefore, it is a major concern to modify the conventional network access protocols so as to prevent foreseeable problems of network re-entry, in which a potentially large number of wireless communication devices are attempting to access the network simultaneously.

### SUMMARY OF THE INVENTION

A network access method is introduced herein. According to an exemplary embodiment, the network access method is adapted for a base station assigning random access parameters, and includes following steps: transmitting a first message, comprising pre-configured information regarding back-off instruction indices (BIIs), to all wireless communication devices within radio service coverage of the base station, and transmitting a second message, indicating respectively assigned BIIs to all the wireless communication devices.

A network access method is introduced herein. According to an exemplary embodiment, the network access method is adapted to a wireless communication device, and includes following steps: determining random back-off timing before performing network access according to an instruction provided in pre-configured information comprising back-off instruction indices (BIIs).

A base station is introduced herein. According to an exemplary embodiment, the base station includes a transceiver module and a communication protocol module. The transceiver module is configured for transmitting signal to and receiving signal from at least a wireless communication device. The communication protocol module is connected to the transceiver module, and configured for transmitting a first message, comprising pre-configured information regarding back-off instruction indices (BIIs), to all wireless communication devices within radio service coverage of the base station, and transmitting a second message, indicating respectively assigned BIIs to all the wireless communication devices.

A wireless communication device is introduced herein. According to an exemplary embodiment, the wireless communication device includes a transceiver module and a communication protocol module. The transceiver module is configured for transmitting signal to and receiving signal from a base station. The communication protocol module is connected to the transceiver module, and configured for determining random back-off timing before performing network access according to an instruction provided in pre-configured information comprising back-off instruction indices (BIIs).

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 illustrates resultant probability distribution function shapes for access timing with different BIT values according to an exemplary embodiment.

FIG. 2 is a functional block diagram illustrating a base station according to an exemplary embodiment.

FIG. 3 is a functional block diagram illustrating a wireless communication device according to an exemplary embodiment.

FIG. 4 is a flowchart illustrating a network access method according to an exemplary embodiment.

FIG. 5 is a flowchart illustrating a network access method according to an exemplary embodiment.

FIG. 6 is a flowchart illustrating a network access method according to an exemplary embodiment.

FIG. 7 is a flowchart illustrating a network access method according to an exemplary embodiment.

FIG. 8 is a flowchart illustrating a network access method according to an exemplary embodiment.

FIG. 9 is a flowchart illustrating a network access method according to an exemplary embodiment.

### DESCRIPTION OF EMBODIMENTS

Some embodiments of the present application will now be described more fully hereinafter with reference to the accompanying drawings, in which some, but not all embodiments of the application are shown. Indeed, various embodiments of the application may be embodied in many different forms and should not be construed as limited to the embodiments set forth herein; rather, these embodiments are provided so that this disclosure will satisfy applicable legal requirements. Like reference numerals refer to like elements throughout.

In the present disclosure, there are proposed functionalities of prioritized random access (also known as ranging) method to satisfy the delay requirements of most Machine-to-Machine applications (M2M applications, also called the MTC type applications). Therefore, the conventional random access protocols are modified so as to achieve prioritized random access with congestion detection and contention resolution mechanisms.

Throughout the disclosure, a wireless communication device could refer to a user equipment (UE), a mobile station, an advanced mobile stations, a wireless terminal communication device, a M2M device, a MTC device, and so forth. The wireless communication device can be, for example, a digital television, a digital set-top box, a personal computer, a notebook PC, a tablet PC, a netbook PC, a mobile phone, a smart phone, a water meter, a gas meter, an electricity meter, an emergency alarm device, a sensor device, a video camera, and so forth. Also, the base station (BS) can refer to an advanced base station (ABS), a node B, an enhanced node B (eNB), and so forth.

In the present disclosure, the term “downlink” (DL) refers to the RF signal transmission from a base station to a wireless communication device within the radio coverage of the base station; the term “uplink” (UL) refers to the RF signal transmission from a wireless communication device to its access base station.

The present disclosure proposes a network access method for wireless communication devices in wireless communication systems. It is assumed, in the present disclosure, that all ranging (random access) attempts can be classified into several priority levels in advance according to their respective priority or delay requirements. From other perspectives, wireless communication devices can be classified into different priority group according to their respective service requirements or delay requirements. The proposed network access method can guarantee that a high priority ranging (random access attempt) should be served earlier than a low priority ranging (random access attempt). In particular, the proposed network access method can be seen as a network re-entry method for the idle mode wireless communication devices, which intends to re-enter the wireless communication device. Also, the proposed network access method can be seen as ranging (random access) parameter assignment method for a base station, and the high priority ranging (random access attempt) can be guaranteed to be served earlier than the low priority ranging (random access attempt) through such ranging (random access) parameter assignment scheme.

The group paging could be used for M2M devices, and M2M group identifier (MGID) defined in IEEE 802.16p specification is included in a paging message instead of an individual device identifier to identify the group of M2M devices. Therefore, for the network re-entry procedure indicated by a group paging message that contains ranging (random access) configuration, M2M devices can select a ranging (random access) opportunity according to the ranging (random access) configuration. In the present disclosure, the ranging (random access) configuration can include a differentiated waiting offset time (before performing another ranging procedure) and a back-off window size (for the ranging procedure).

In the present disclosure, there is proposed a network access method with an “Instruction Table with Non-Uniform Back-off Timing” concept. In fact, the “Instruction Table” for the proposed network access method can be pre-defined information delivered to wireless communication devices within the radio service coverage of a wireless communication network or that of a base station through system information broadcast. Alternatively, the pre-defined information regarding the “Instruction Table” for the network access method built-in the wireless communication devices.

For M2M applications, it is widely anticipated that the conventional random back-off mechanisms are not able to handle network congestion issues properly, and some M2M devices might have to suffer unacceptable latency. It is considered a scenario where multiple M2M device groups are paged at the same time. A large number of M2M devices carrying out network re-entry procedure simultaneously can cause severe resource congestion. In the conventional random back-off schemes, each wireless communication device determines its access timing based on a uniform probability density function (PDF). The present disclosure proposes an alternative network access method for allowing wireless communication devices to randomly pick up their respective access timings based on non-uniform PDFs. It is clear that the probability of collision between two wireless communication devices could be reduced when they use different PDFs.

In the present disclosure, all devices (as well as the access point or the base station) possess knowledge of a common, pre-configured back-off instruction table (or pre-configured information) with multiple indices (e.g. shown in Table I below). Each one of the indices (denoted as back-off instruction index or abbreviated as BII) is associated with a back-off instruction, which provides information on items such as: waiting time offset; distribution shape parameters; timing calculation formulas (or formulae); ranging (random access) back-off window; ranging (random access) opportunities; resource opportunities; location for random access, and so forth.

TABLE I
An example of Back-off Instruction Table for An Embodiment

| BII | Offset (T) | β |
|---|---|---|
| 0 | 0 | 0 |
| 1 | 0 | 1 |
| 2 | T | 0 |
| 3 | T | 1 |

Each instruction encompasses some or all of the items listed above. It is noted that the “distribution shape parameters” refer to any parameter that can alter the shapes of PDFs employed by the wireless communication devices to pick up their respective random back-off timings. For example, the timing calculation formula may have the following form (shown as equation (1)), The access time, t, can be computed by the wireless communication device as:

t=T+|U^{α}(0,1)−β|×S Equation (1),

where T denotes a waiting time offset, α and β respectively stand for distribution shape parameters, and S is the ranging back-off window. From other perspectives along with the Table II, T is the offset, β is a distribution shape controller, U(0,1) is a uniform random variable between 0 and 1.

By looking up the table in the wireless communication device, or checking the pre-configured information in the wireless communication device, the wireless communication device can decide its random back-off timing by following the instruction mapping to the BII value that it has been assigned to.

There are two possible ways to determine BII assignments such as network determination and a built-in determination. The “Network Determination” depends on the instantaneous traffic condition and/or application requirements, the network (or the paging server or the base station) thus determines BIT value for each pre-configured group (or each wireless communication device), and then assign the BII value to the wireless communication devices through paging. The “Built-In Determination” refers to the cases that each of the wireless communication devices has a built-in priority level, and thus the wireless communication device can autonomously determine their respective BII values based on the built-in priority levels.

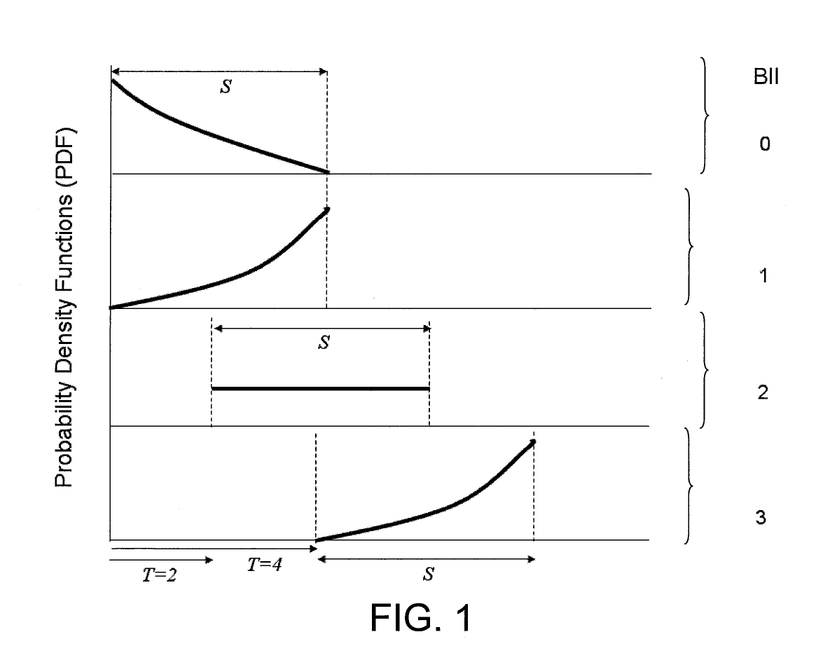

In Table II shown below, T is the waiting time offset, β is distribution shape controller, U(0,1) is a uniform random variable between 0 and 1, and S is the size of ranging back-off window. The resultant probability density functions (PDFs) for different BII values in Table II are shown in FIG. 1. FIG. 1 illustrates resultant probability distribution function shapes for access timing with different BII values 0, 1, 2, 3 according to the exemplary embodiment. The BII value 0, 1, 2, 3 can be assigned to different priority groups (or M2M device groups) according to their respective service requirements or delay requirements.

It is shown in FIG. 1 that wireless communication devices with smaller BII values are more likely to win the earlier time slot, such that the wireless communication devices with higher priority levels should be assigned to smaller BII value in this particular example. For an illustrative example, it is presumed that the PDF shapes in FIG. 1 uses a Back-off Instruction Table as shown in Table II.

TABLE II
An exemplary Back-off Instruction Table

| RII | Offset (T) | β | Formulas for Timing Calculations |
|---|---|---|---|
| 0 | 0 | 0 | t = T + \|U² (0, 1) − β\| × S |
| 1 | 0 | 1 | t = T + \|U² (0, 1) − β\| × S |
| 2 | 2 | 0 | t = T + \|U (0, 1) − β\| × S |
| 3 | 4 | 1 | t = T + \|U² (0, 1) − β\| × S |

The RII assignment can be implemented by modifying the paging message as following Table III. It is noted that Table xxx in the description column corresponding to the field of “RII” refers to a pre-configuration (pre-configured information) of different sets of ranging (random access) parameters.

TABLE III
Paging Message contains RII Assignment

| | | Size | | |
|---|---|---|---|---|
| Field | | (bits) | Value/Description | Condition |
| Nun_PAG_GRP | | TBD | The number of M2M groups | |
| | | | to be paged | |
| For (j=0; | | | | |
| j<Num_PAG_GRP; J++){ | | | | |
| | Group ID | TBD | M2M Group ID | |
| | Action Code | 1 | 0b0: Perform network re-entry | |

| | | | 0b1: Perform location update | |
|---|---|---|---|---|
| Ranging_Instruction_Index | | TBD | The device should use the | Present if |
| | (RII) | | ranging parameters | network |

| | | |
|---|---|---|
| | corresponding to the assigned | re-entry is |
| | RII in accordance to Table xxx | required |
| | | (Action) |
| } | | |

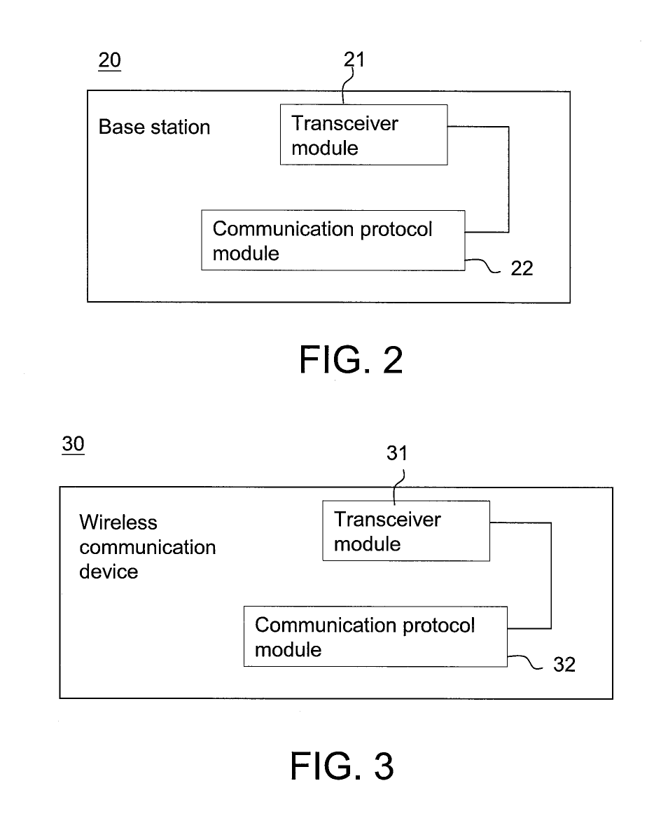

FIG. 2 is a functional block diagram illustrating a base station according to an exemplary embodiment. Referring to FIG. 2, the base station 20 includes a transceiver module 21 and a communication module 22. The transceiver module 21 is configured for transmitting signal to and receiving signal from one or more wireless communication devices within its radio service coverage. The communication protocol module 22 is connected to the transceiver module 21, and configured for assigning random access parameters to the wireless communication devices and processing network access requests from the wireless communication devices. In addition, the base station 20 can include other components (not illustrated) such as a processor module, a memory module, a fixed network module and an antenna module for connecting to other processing units in the wireless communication network as well as processing signals from one or more wireless communication devices within its radio service coverage.

FIG. 3 is a functional block diagram illustrating a wireless communication device according to an exemplary embodiment. Referring to FIG. 3, the wireless communication device 30 includes a transceiver module 31 and a communication protocol module 32. The transceiver module 31 is configured for transmitting signal to and receiving signal from a base station. The communication protocol module 32 is connected to the transceiver module 31, and configured for performing random back-off procedure and performing network access request to the base station. In addition, the wireless communication device 30 can include other components (not illustrated) such as a processor module, a memory module, and an antenna module for processing signals from a base station.

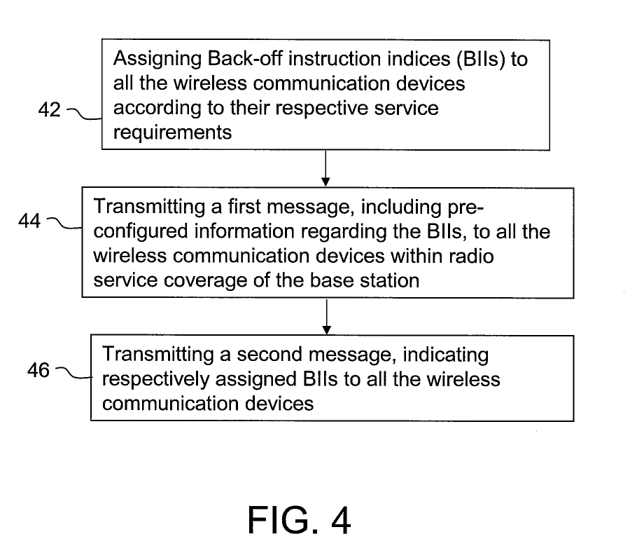

FIG. 4 is a flowchart illustrating a network access method according to an exemplary embodiment. Referring to FIG. 4, the network access method is adapted for a base station to assign random access parameters, and initiates from step 42, in which the communication protocol module 22 of the base station 20 assigns Back-off instruction indices (BIIs) to all the wireless communication devices within its radio service coverage according to their respective service requirements. In step 44, the communication protocol module 22 transmits a first message, including pre-configured information regarding the BIIs, to all the wireless communication devices within the radio service coverage of the base station 20.

In step 46, the communication protocol module 22 transmits a second message, indicating respectively assigned BIIs to all the wireless communication devices. The pre-configured information is a pre-configured BII table, or includes a set of parameters relating to statistical distribution of random access back-off timing for network re-entry, or includes a set of mathematical equations relating to statistical distribution of random access back-off timing for network re-entry. The pre-configured information associated with each one of the BIIs includes a timing calculation formula, probability density functions of random back-off timing, and/or parameters that affects probability functions of accessing timings or required for the timing calculation formula or the probability density functions.

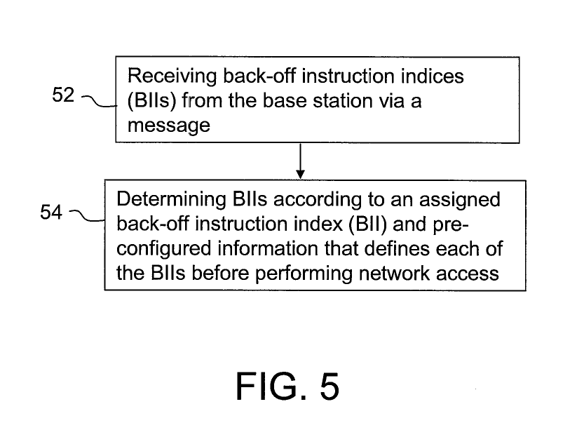

FIG. 5 is a flowchart illustrating a network access method according to an exemplary embodiment. Referring to FIG. 5, the network access method is adapted for the wireless communication device 30, and initiates from step 52, in which the communication protocol module 32 of the wireless communication device 30 receives Back-off Instruction Indices (BIIs) from a base station via a message. In step 54, the communication protocol module 32 determines random back-off timing according to an assigned back-off instruction index (BII) and pre-configured information that defines each of the BIIs before performing network access. Then, the communication protocol module 32 is configured to perform the network access after waiting for the random back-off timing.

The pre-configured information is a pre-configured BIT table, or includes a set of parameters relating to statistical distribution of random access back-off timing for network re-entry, or includes a set of mathematical equations relating to statistical distribution of random access back-off timing for network re-entry. The parameters affects probability density functions of access timings, at which the communication protocol module 32 performs a random access attempts. Alternatively, the pre-configured information associated with each one of the BIIs includes a timing calculation formula, probability density functions of random back-off timing, and/or parameters that affects probability density functions of access timings or required for the timing calculation formula.

In the present embodiment, when the wireless communication device 30 is a delay-sensitive device, the wireless communication device 30 is configured to perform the network access according to a BII value that corresponds to a higher probability of being served earlier than another wireless communication device, which performs the network access according to another BII value.

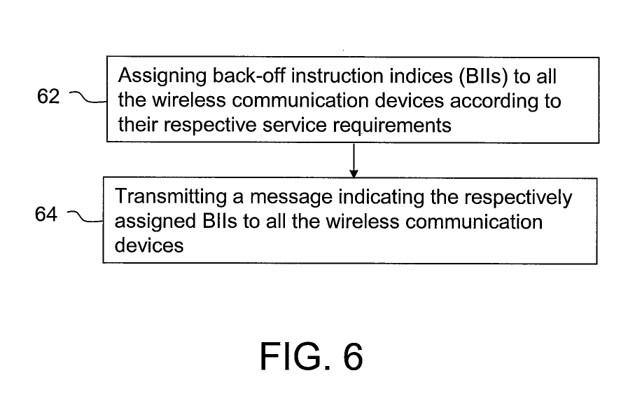

FIG. 6 is a flowchart illustrating a network access method according to an exemplary embodiment. Referring to FIG. 6, the network access method is adapted to a base station, and initiates from step 62, in which the communication protocol module 22 of the base station 20 assigns Back-off instruction indices (BIIs) to all the wireless communication devices within its radio service coverage according to their respective service requirements. In step 64, the communication protocol module 22 transmits a message indicating the respectively assigned BIIs to all the wireless communication devices within the radio service coverage of the base station 20, where all the wireless communication has a BIIs table, and the BIIs table includes pre-configured information. For example, all the wireless communication devices, within the radio service coverage of the base station 20, are built-in with the back-off instruction indices (BIIs) table, which includes pre-configured information.

Further, in the present embodiment, the pre-configured information can include a set of BIIs, and each BII associates to a set of parameters relating to statistical distribution of random access back-off timing for network re-entry. Alternatively, the pre-configured information can include a set of BIIs, and each BII associates to a mathematical equation relating to statistical distribution of random access back-off timing for network re-entry. Also, the pre-configured information can be associated with the BIIs, where the pre-configured information associated with each one of the BIIs can include a timing calculation formula, probability density functions of random back-off timing, and/or parameters required for the timing calculation formula or the probability density functions.

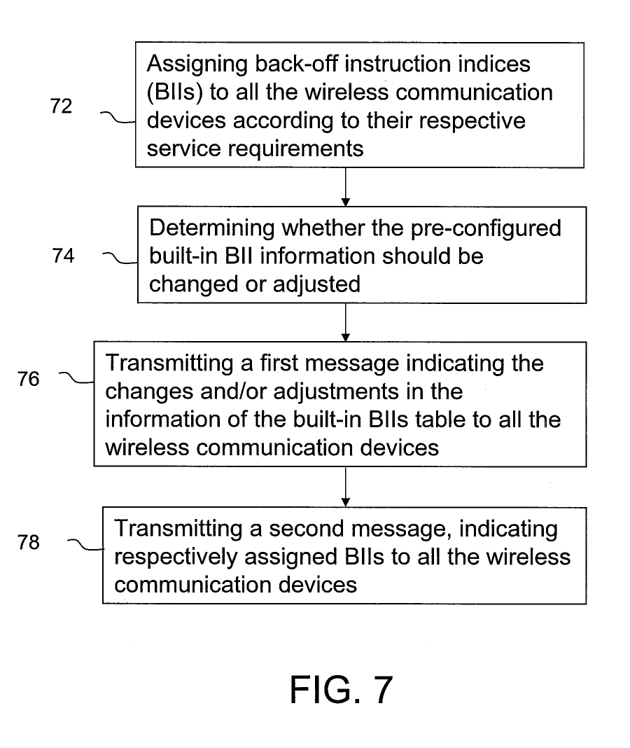

FIG. 7 is a flowchart illustrating a network access method according to an exemplary embodiment. Referring to FIG. 7, the network access method is adapted for a base station to assign random access parameters, and initiates from step 72, in which the communication protocol module 22 of the base station 20 assigns Back-off instruction indices (BIIs) to all the wireless communication devices within its radio service coverage according to their respective service requirements. In the step 74, the communication protocol module 22 determines if the pre-configured built-in BII information should be changed or adjusted. In step 76, the communication protocol module 22 transmits a first message, indicating the changes and/or adjustments in the information of the built-in BIIs table to all the wireless communication devices within the radio service coverage of the base station 20.

In step 78, the communication protocol module 22 transmits a second message, indicating respectively assigned BIIs to all the wireless communication devices. The technical details of Ms can be referred to relevant descriptions related to FIGS. 1, 4 and 6.

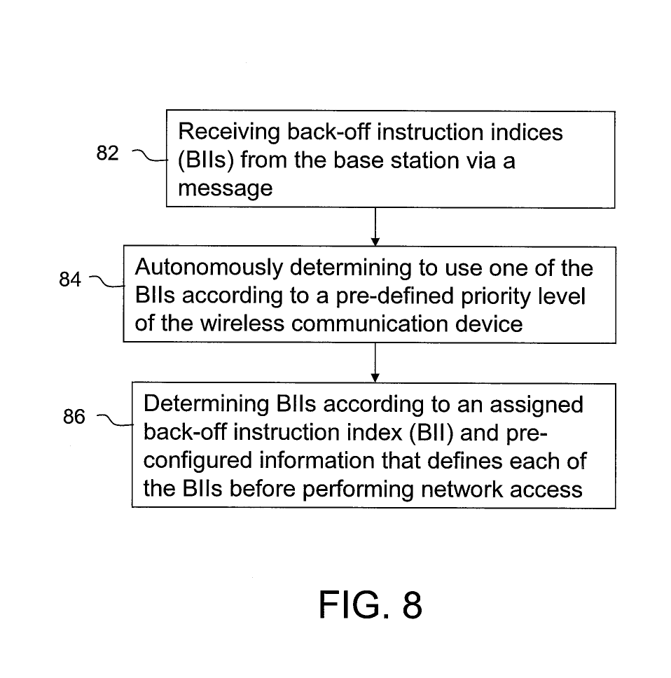

FIG. 8 is a flowchart illustrating a network access method according to an exemplary embodiment. Referring to FIG. 8, the network access method is adapted for a wireless communication device, and initiates from step 82, in which the communication protocol module 32 of the wireless communication device 30 receives Back-off Instruction Indices (BIIs) from a base station via a message. In step 84, the communication protocol module 32 autonomously determines to use one of the BIIs according to a pre-defined priority level of the wireless communication device 30.

In step 86, the communication protocol module 32 determines random back-off timing according to an assigned back-off instruction index (BII) and pre-configured information that defines each of the BIIs before performing network access. Then, the communication protocol module 32 is configured to perform the network access after waiting for the random back-off timing. The technical details of BIIs can be referred to relevant descriptions related to FIG. 1 and FIG. 5.

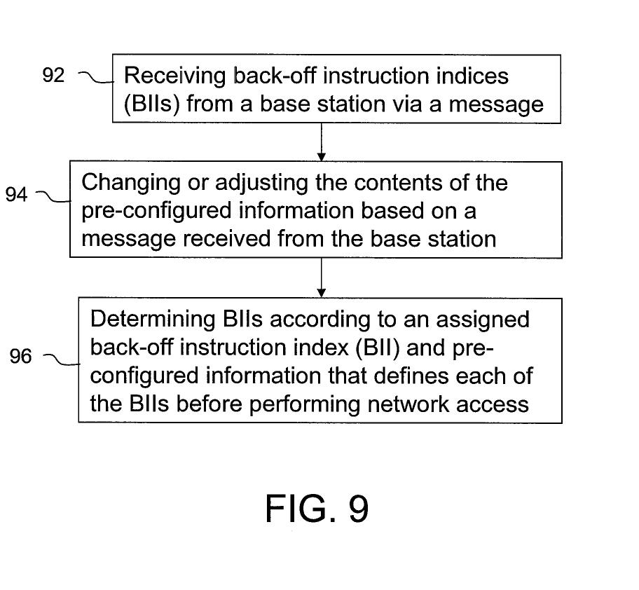

FIG. 9 is a flowchart illustrating a network access method according to an exemplary embodiment. Referring to FIG. 9, the network access method is adapted for a wireless communication device, and initiates from step 92, in which the communication protocol module 32 of the wireless communication device 30 receives Back-off Instruction Indices (BIIs) from a base station via a message. In step 84, the communication protocol module 32 changes or adjusts the contents of the pre-configured information based on a message received from the base station 20.

In step 96, the communication protocol module 32 determines random back-off timing according to an assigned back-off instruction index (BII) and pre-configured information that defines each of the BIIs before performing network access. Then, the communication protocol module 32 is configured to perform the network access after waiting for the random back-off timing. The technical details of BIIs can be referred to relevant descriptions related to FIG. 1 and FIG. 5.

In summary, according to the exemplary embodiments of the disclosure, network access methods and wireless communication devices and base stations using the same methods are proposed. The proposed method relies on random access parameters assignment through pre-configured information and non-uniform distribution of access timings corresponding to pre-assigned priority group.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A network access method, adapted for a base station assigning random access parameters, comprising:
assigning BIIs to all the wireless communication devices within radio service coverage of the base station according to their respective service requirements;
transmitting a message indicating the respectively assigned BIIs to all the wireless communication devices; and
wherein all the wireless communication devices are built-in with a back-off instruction indices (BIIs) table, comprising pre-configured information.

2. The network access method according to claim 1, wherein before transmitting the message, the network access method further comprises:
transmitting a message indicating the changes and/or adjustments in the information of the built-in BIIs table to all the wireless communication devices.

3. The network access method according to claim 1, wherein the pre-configured information comprises a set of BIIs, and each BII associates to a set of parameters relating to statistical distribution of random access back-off timing for network re-entry.

4. The network access method according to claim 1, wherein the pre-configured information associated with each one of the BIIs comprises a timing calculation formula, probability density functions of random back-off timing, and/or parameters that affects probability density functions of access timings or required for the timing calculation formula.

5. A network access method, adapted to a wireless communication device, comprising:
determining random back-off timing in accordance to an assigned back-off instruction index (BII) and pre-configured information that defines each of the BIIs before performing network access.

6. The network access method according to claim 5, wherein before determining the random back-off timing, the method further comprising:
autonomously determining to use one of the BIN according to a pre-defined priority level of the wireless communication device.

7. The network access method according to claim 5, wherein the pre-configured information associated with each one of the BIIs comprises a timing calculation formula, probability density functions of random back-off timing, and/or parameters that affects probability density functions of access timings or required for the timing calculation formula.

8. The network access method according to claim 5, wherein before determining the random back-off timing according to the instruction provided in the pre-configured information, the method further comprising:
receiving BIN from the base station via a message.

9. The network access method according to claim 5, wherein when the wireless communication device is a delay-sensitive device, the wireless communication device performing the network access according to a BII value that corresponds to a higher probability of being served earlier than another wireless communication device, which performs the network access according to another BII value.

10. A base station, comprising:
a transceiver module, configured for transmitting signal to and receiving signal from at least a wireless communication device;
a communication protocol module, connected to the transceiver module, configured for transmitting a message, indicating respectively assigned BIIs to all the wireless communication devices.

11. The base station according to claim 10, wherein before transmitting the message, the communication protocol module determines if the pre-configured built-in BII information should be changed or adjusted by transmitting a message indicating the changes to all wireless communication devices.

12. The base station according to claim 10, wherein before transmitting the message, the communication protocol module assigns BIIs to all the wireless communication devices according to their respective service requirements.

13. The base station according to claim 10, wherein the pre-configured information associated with each one of the BIIs comprises a timing calculation formula, probability density functions of random back-off timing, and/or parameters that affects probability density functions of access timings or required for the timing calculation formula.

14. A wireless communication device, comprising:
a transceiver module, configured for transmitting signal to and receiving signal from a base station;
a communication protocol module, connected to the transceiver module, configured for determining random back-off timing before performing network access according to an instruction provided in pre-configured information comprising back-off instruction indices (BIIs).

15. The wireless communication device, according to claim 14, wherein before determining the random back-off timing, the communication protocol module autonomously determines to use one of the Ms according to a pre-defined priority level of the wireless communication device.

16. The wireless communication device according to claim 14, wherein pre-configured information associated with each one of the BIIs comprises a timing calculation formula, probability density functions of random back-off timing, and/or parameters that affects probability density functions of access timings or required for the timing calculation formula.

17. The wireless communication device according to claim 14, wherein before determining the random back-off timing before performing the network re-entry attempt according to the instruction provided in the pre-configured information, the communication protocol module changes or adjust the contents of the pre-configured information based on a message received from the base station.

18. The wireless communication device according to claim 14, wherein before determining the random back-off timing before performing the network re-entry attempt according to the instruction provided in the pre-configured information, the communication protocol module receives BIIs from the base station via a message.

19. The wireless communication device according to claim 14, wherein when the wireless communication device is a delay-sensitive device, the communication protocol module performs the network access according to a BII value that corresponds to a higher probability of being served earlier than another wireless communication device, which performs the network access according to another BII value.
